(19) United States
(12) Patent Application Publication
(10) Pub. No.: US 2026/0032716 A1
(43) Pub. Date: Jan. 29, 2026

(54) METHODS AND APPARATUSES FOR HANDLING CONFLICTS

(71) Applicant: LENOVO (BEIJING) LIMITED, Beijing (CN)

(72) Inventors: Yu Zhang, Beijing (CN); Haipeng Lei, Beijing (CN)

(21) Appl. No.: 18/998,166

(22) PCT Filed: Jul. 26, 2022
(86) PCT No.: PCT/CN2022/107887

§ 371 Date: Jan. 24, 2025

(51) Int. Cl. H04W 72/56; H04L 5/14

(52) U.S. Cl. CPC H04W 72/56; H04L 5/14

(57) ABSTRACT

The present application relates to methods and apparatuses for handling conflicts. An embodiment of the present disclosure provides a user equipment (UE), which includes: a transceiver; and a processor coupled with the transceiver and configured to: receive a first indication associated with a first uplink (UL) transmission in a first set of symbols; receive a second indication associated with a first downlink (DL) reception in a second set of symbols; determine a set of remaining symbols based on a first priority level associated with the first UL transmission and a second priority level associated with the first DL reception; and perform one of the following: perform the first UL transmission in the first set of symbols and a second DL reception in the set of remaining symbols in the case that the set of remaining symbols is included in the second set of symbols: or perform the first DL reception in the second set of symbols and a second UL transmission in the set of remaining symbols in the case that the set of remaining symbols is included in the first set of symbols.

### TECHNICAL FIELD

The present disclosure relates to wireless communication technologies, and especially to methods and apparatuses for handling conflicts.

### BACKGROUND OF THE INVENTION

Time division duplexing (TDD) is widely used in wireless networks. When operating TDD in a wireless network, only one transmission direction, that is, downlink (DL) or uplink (UL) is supported in a given time duration. However, allocation of limited time duration for the UL transmissions would result in reduced coverage and increased latency. Therefore, it would be worth allowing the simultaneous existence of DL transmissions and UL transmissions in a given time duration, a.k.a. full duplex. More specifically, subband non-overlapping full duplex (SBFD) mode can be implemented in a wireless network, that is, the network can support simultaneous UL transmissions and DL transmissions occupying the non-overlapping subbands.

However, for a device which doesn't support transmitting and receiving simultaneously in a network implementing SBFD mode, there may be some conflicts between performing UL transmissions and receiving DL transmissions, and the present disclosure proposes some solutions for handling these conflicts.

### SUMMARY

An embodiment of the present disclosure provides a user equipment (UE), which includes: a transceiver; and a processor coupled with the transceiver and configured to: receive a first indication associated with a first uplink (UL) transmission in a first set of symbols; receive a second indication associated with a first downlink (DL) reception in a second set of symbols; determine a set of remaining symbols based on a first priority level associated with the first UL transmission and a second priority level associated with the first DL reception; and perform one of the following: perform the first UL transmission in the first set of symbols and a second DL reception in the set of remaining symbols in the case that the set of remaining symbols is included in the second set of symbols; or perform the first DL reception in the second set of symbols and a second UL transmission in the set of remaining symbols in the case that the set of remaining symbols is included in the first set of symbols.

In some embodiments, in the case that the first priority level is lower than the second priority level, or in the case that the first priority level is equal to the second priority level and the first DL reception is prioritized, the set of remaining symbols is included in the first set of symbols, and is neither overlapped with the second set of symbols nor used as a gap for UL/DL switching.

In some embodiments, in the case that the first priority level is higher than the second priority level, or in the case that the first priority level is equal to the second priority level and the first UL transmission is prioritized, the set of remaining symbols is included in the second set of symbols, and is neither overlapped with the first set of symbols nor used as a gap for UL/DL switching.

In some embodiments, the set of remaining symbols includes one or more symbols for at least one of: a demodulation reference signal (DMRS) transmission or at least one code block group (CBG) transmission.

In some embodiments, the DMRS transmission is mapped from a first symbol in the set of remaining symbols.

In some embodiments, a configured grant uplink control information (CG-UCI) transmission is mapped from a symbol following symbol(s) for the DRMS transmission in the set of remaining symbols.

In some embodiments, the second UL transmission in the set of remaining symbols is one of the following: a punctured first UL transmission; an UL transmission carrying a transport block (TB) different from a TB carried in the first UL transmission in the case that a total number of symbols of the set of remaining symbols is larger than or equal to a first number; or an UL transmission carrying the TB carried in the first UL transmission in the case that a total number of symbols of the set of remaining symbols is larger than a second number and a code rate corresponding to the second UL transmission is smaller than a third number.

In some embodiments, the second DL reception in the set of remaining symbols includes one of the following: a punctured first DL reception; a DL reception carrying a TB different from a TB carried in the first DL reception in the case that a total number of symbols of the set of remaining symbols is larger than or equal to a fourth number; or a DL reception carrying the TB carried in the first DL reception in the case that a total number of symbols of the set of remaining symbols is larger than a fifth number and a code rate corresponding to the second UL reception is smaller than a sixth number.

In some embodiments, the processor is further configured to: transmit a third indication indicating an UL transmission or a DL reception is prioritized in the case that a priority level associated with the UL transmission is equal to a priority level associated with the DL reception; or receive a fourth indication indicating an UL transmission or a DL reception is prioritized in the case that a priority level associated with the UL transmission is equal to a priority level associated with the DL reception.

In some embodiments, the processor is further configured to: drop the first UL transmission in the case that the first priority level is lower than the second priority level, or in the case that the first priority level is equal to the second priority level and the first DL reception is prioritized, wherein one of the following condition is fulfilled: the first UL transmission is not a CBG-based transmission, a total number of symbols of the set of remaining symbols is smaller than a first number; a total number of symbols of the set of remaining symbols is smaller than or equal to a second number, or a code rate corresponding to the second UL transmission is larger than or equal to a third number; or drop the first DL reception in the case that the first priority level is higher than the second priority level, or in the case that the first priority level is equal to the second priority level and the first UL transmission is prioritized, wherein one of the following condition is fulfilled: the first DL reception is not a CBG-based reception; a total number of symbols of the set of remaining symbols is smaller than a fourth number; or a total number of symbols of the set of remaining symbols is smaller than or equal to a fifth number, or a code rate corresponding to the second UL reception is larger than or equal to than a sixth number.

Another embodiment of the present disclosure provides a base station (BS), which includes: a transceiver; and a processor coupled with the transceiver and configured to: transmit a first indication associated with a first UL reception in a first set of symbols; transmit a second indication associated with a first DL transmission in a second set of symbols; determine a set of remaining symbols based on a first priority level associated with the first UL reception and a second priority level associated with the first DL transmission; and perform one of the following: perform the first UL reception in the first set of symbols and a second DL transmission in the set of remaining symbols in the case that the set of remaining symbols is included in the second set of symbols; or perform the first DL transmission in the second set of symbols and a second UL reception in the set of remaining symbols in the case that the set of remaining symbols is included in the first set of symbols.

In some embodiments, in the case that the first priority level is lower than the second priority level, or in the case that the first priority level is equal to the second priority level and the first DL transmission is prioritized, the set of remaining symbols is included in the first set of symbols, and is neither overlapped with the second set of symbols nor used as a gap for UL/DL switching.

In some embodiments, in the case that the first priority level is higher than the second priority level, or in the case that the first priority level is equal to the second priority level and the first UL reception is prioritized, the set of remaining symbols is included in the second set of symbols, and is neither overlapped with the first set of symbols nor used as a gap for UL/DL switching.

In some embodiments, the set of remaining symbols includes one or more symbols for at least one of: a DMRS transmission or at least one CBG transmission.

In some embodiments, the DMRS transmission is mapped from a first symbol in the set of remaining symbols.

In some embodiments, a CG-UCI transmission is mapped from a symbol following symbol(s) for the DRMS transmission in the set of remaining symbols.

In some embodiments, the second UL reception in the set of remaining symbols is one of the following: a punctured first UL reception; an UL reception carrying a TB different from a TB carried in the first UL reception in the case that a total number of symbols of the set of remaining symbols is larger than or equal to a first number; or an UL reception carrying the TB carried in the first UL reception in the case that a total number of symbols of the set of remaining symbols is larger than a second number and a code rate corresponding to the second UL transmission is smaller than a third number.

In some embodiments, the second DL transmission in the set of remaining symbols includes one of the following: a punctured first DL transmission; a DL transmission carrying a TB different from a TB carried in the first DL transmission in the case that a total number of symbols of the set of remaining symbols is larger than or equal to a fourth number; or a DL transmission carrying the TB carried in the first DL transmission in the case that a total number of symbols of the set of remaining symbols is larger than a fifth number and a code rate corresponding to the second DL transmission is smaller than a sixth number.

In some embodiments, the processor is further configured to: transmit a third indication indicating an UL reception or a DL transmission is prioritized in the case that a priority level associated with the UL transmission is equal to a priority level associated with the DL transmission; or receive a fourth indication indicating an UL reception or a DL transmission is prioritized in the case that a priority level associated with the UL reception is equal to a priority level associated with the DL transmission.

In some embodiments, the processor is further configured to: drop the first UL reception in the case that the first priority level is lower than the second priority level, or in the case that the first priority level is equal to the second priority level and the first DL transmission is prioritized, wherein one of the following condition is fulfilled: the first UL reception is not a CBG-based reception, a total number of symbols of the set of remaining symbols is smaller than a first number; a total number of symbols of the set of remaining symbols is smaller than or equal to a second number, or a code rate corresponding to the second UL transmission is larger than or equal to a third number; or drop the first DL transmission in the case that the first priority level is higher than the second priority level, or in the case that the first priority level is equal to the second priority level and the first UL reception is prioritized, wherein one of the following condition is fulfilled: the first DL transmission is not a CBG-based transmission; a total number of symbols of the set of remaining symbols is smaller than a fourth number; or a total number of symbols of the set of remaining symbols is smaller than or equal to a fifth number, or a code rate corresponding to the second UL reception is larger than or equal to than a sixth number.

Yet another embodiment of the present disclosure provides a method performed by a UE, which includes: receiving a first indication associated with a first UL transmission in a first set of symbols; receiving a second indication associated with a first DL reception in a second set of symbols; determining a set of remaining symbols based on a first priority level associated with the first UL transmission and a second priority level associated with the first DL reception; and performing one of the following: performing the first UL transmission in the first set of symbols and a second DL reception in the set of remaining symbols in the case that the set of remaining symbols is included in the second set of symbols; or performing the first DL reception in the second set of symbols and a second UL transmission in the set of remaining symbols in the case that the set of remaining symbols is included in the first set of symbols.

Still another embodiment of the present disclosure provides a method performed by a BS, which includes: transmitting a first indication associated with a first UL reception in a first set of symbols; transmitting a second indication associated with a first DL transmission in a second set of symbols; determining a set of remaining symbols based on a first priority level associated with the first UL reception and a second priority level associated with the first DL transmission; and performing one of the following: performing the first UL reception in the first set of symbols and a second DL transmission in the set of remaining symbols in the case that the set of remaining symbols is included in the second set of symbols; or performing the first DL transmission in the second set of symbols and a second UL reception in the set of remaining symbols in the case that the set of remaining symbols is included in the first set of symbols.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a wireless communications system in accordance with some embodiments of the present disclosure.

FIG. 2 illustrates an allocation of sets of resource elements (REs) corresponding to simultaneous UL and DL transmissions when operating a subband non-overlapping full duplex mode in accordance with some embodiments of the present disclosure.

FIG. 3A and FIG. 3B illustrate some scenarios where a conflict occurs between a DL reception and an UL transmission in accordance with some embodiments of the present disclosure.

FIG. 4A illustrates a method for handling conflicts in accordance with some embodiments of the present disclosure.

FIG. 4B illustrates another method for handling conflicts in accordance with some embodiments of the present disclosure.

FIGS. 5A-5D illustrate some mapping methods in accordance with some embodiments of the present disclosure

FIG. 6 illustrates a method performed by a UE for handling conflicts in accordance with some embodiments of the present disclosure.

FIG. 7 illustrates a method performed by a BS for handling conflicts in accordance with some embodiments of the present disclosure.

FIG. 8 illustrates a simplified block diagram of an apparatus for handling conflicts in accordance with some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as a cellular telephone network, a time division multiple access (TDMA)-based network, a code division multiple access (CDMA)-based network, an orthogonal frequency division multiple access (OFDMA)-based network, a LTE network, a 3^{rd} generation partnership project (3GPP)-based network, LTE, LTE-Advanced (LTE-A), 3GPP 4G, 3GPP 5G NR, 3GPP Release 16 and onwards, a satellite communications network, a high altitude platform network, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

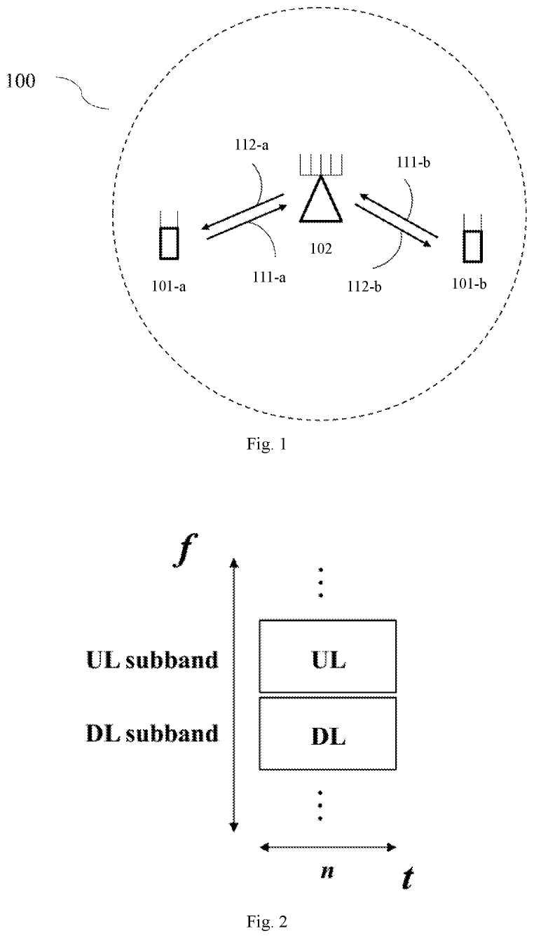

FIG. 1 illustrates a wireless communications system 100 in accordance with some embodiments of the present disclosure.

Referring to FIG. 1, the wireless communications system 100 may include one or more UEs (e.g., UE 101-a and UE 101-b, collectively referred to as UEs 101), and at least a BS 102. Although a specific number of UEs 101 and BS 102 are depicted in FIG. 1, it is contemplated that any number of UEs and BSs may be included in the wireless communications system 100.

In some embodiments of the present disclosure, the UEs 101 may be devices in different forms or having different capabilities. According to some embodiments of the present disclosure, the UEs 101 may include or may be referred to as computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UEs 101 may include or may be referred to as portable wireless communication devices, such as smart phones, cellular telephones, flip phones, or any other device that is capable of transmitting and receiving information. In some embodiments, the UEs 101 may include or may be referred to as wearable devices, such as smart watches, fitness bands, optical head-mounted displays, or the like. Moreover, the UEs 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In some embodiments of the present disclosure, the BS 102 may be referred to as an access point, an access terminal, a base, a base unit, a macro cell, a Node B, an enhanced Node B, an evolved Node B, a next generation Node B (gNB), a Home Node B, a relay node, or a device, or described using other terminology used in the art. The BS 102 is generally a part of a radio access network that may include one or more controllers communicably coupled to one or more corresponding BS 102.

The wireless communications system 100 may be compatible with any type of network that is capable of exchanging information between the BS 102 and the UEs 101. For example, the wireless communications system 100 may be a cellular telephone network, a time division multiple access (TDMA)-based network, a code division multiple access (CDMA)-based network, an orthogonal frequency division multiple access (OFDMA)-based network, a 3GPP-based network, a 3GPP LTE network, a 3GPP 5G NR network, a satellite communications network, a high-altitude platform network, or one of other communications networks. More generally, however, the wireless communications system 100 may implement some other open or proprietary communication protocols, for example, IEEE 802.11 family, WiMAX, among other protocols.

In some embodiments of the present disclosure, the BS 102 may be dispersed throughout a geographic area to form the wireless communications system 100 and may be a device in different forms or having different capabilities. The information exchanges between the BS 102 and the UEs 101 in the wireless communications system 100 may include uplink (UL) transmissions (e.g., UL transmission 111-a and UL transmission 111-b, collectively referred to UL transmissions 111) from the UEs 101 to the BS 102, or downlink (DL) transmissions 112 from the BS 102 to the UEs 101 (e.g., DL transmission 112-a and DL transmission 112-b, collectively referred to DL transmissions 112) over one or more carriers. A carrier may be a portion of a radio frequency spectrum band and may be associated with a particular bandwidth (e.g., 20 megahertz (MHz)). A carrier may be made up of multiple subcarriers and a resource block (RB) is defined as 12 consecutive subcarriers. In some examples, there may be multiple subbands within a carrier and each subband may include a number of consecutive RBs. The time intervals for the wireless communications system 100 may be expressed in multiples of a basic time unit and may be organized according to radio frames each having a specified duration (e.g., 10 milliseconds (ms)). In some examples, a radio frame may be divided into subframes, and each subframe may be further divided into a number of slots. Alternatively, each radio frame may include a variable number of slots and each slot includes a number of symbols (e.g., 14 symbols). The UL and DL transmissions may include physical channel transmissions and physical signal transmissions. A physical channel transmission or a physical signal transmission is transmitted on a set of basic time-frequency domain resources having a defined physical layer structure. Each basic time-frequency domain resource may be referred to as a RE which may consist of one symbol in the time domain and one subcarrier in the frequency domain. A set of REs corresponding to a physical channel transmission or a physical signal transmission may span a number of symbols in the time domain and a number of subcarriers within one or more subbands in the frequency domain, that is, the physical channel transmission or the physical signal transmission may be transmitted in a number of symbols and on a number of subcarriers within one or more subbands. In other words, the physical channel transmission or the physical signal transmission may occupy a number of symbols and a number of subcarriers within one or more subbands.

In some embodiments of the present disclosure, for the wireless communications system 100, a subband non-overlapping full duplex mode may be supported for enhanced coverage, reduced latency, improved system capacity, and improved configuration flexibility, that is, there may be simultaneous UL transmission(s) 111-a from the UE 101-a to the BS 102 and DL transmission(s) 112-b from the BS 102 to the UE 101-b, and the UL transmission(s) 111-a and the DL transmission(s) 112-b are transmitted within non-overlapping subbands.

In some embodiments of the present disclosure, for the wireless communications system 100, the UEs 101 may be provided by a first downlink control information (DCI) message and/or a higher layer signaling with a set of REs corresponding to an UL transmission (e.g., a physical uplink shared channel (PUSCH) transmission), that is, the UE can perform the UL transmission on the set of REs. In some other embodiments of the present disclosure, for the wireless communications system 100, the UE 101 may be provided by a second DCI message and/or a higher layer signaling with a set of REs corresponding to a DL transmission (e.g., a physical downlink shared channel (PDSCH) transmission) from the BS 102. If the UL transmission or the DL transmission is a PUSCH transmission or a PDSCH transmission, the UE may further determine a TB carried by the PUSCH transmission or the PDSCH transmission with a size, which is also referred to as TB size. In the context of the present disclosure, for a UE, transmitting a UL transmission may also be referred to as performing a UL transmission or the like, and receiving a DL transmission may also be referred to as performing a DL reception or the like; for a BS, transmitting a DL transmission may also be referred to as performing a DL transmission or the like, and receiving a UL transmission may also be referred to as performing a UL reception or the like.

FIG. 2 illustrates an allocation of sets of REs corresponding to simultaneous UL and DL transmissions when operating a subband non-overlapping full duplex mode. In the example of FIG. 2, slot #n is shown in the time domain (i.e., the horizontal axis marked by “1”), and non-overlapping UL subband and DL subband are shown in the frequency domain (i.e., the vertical axis marked by “f”). A DL transmission (e.g., DL transmission 112-b) may be transmitted in the slot #n within the DL subband, and an UL transmission (e.g., UL transmission 111-a) may be transmitted in the slot #n within the UL subband.

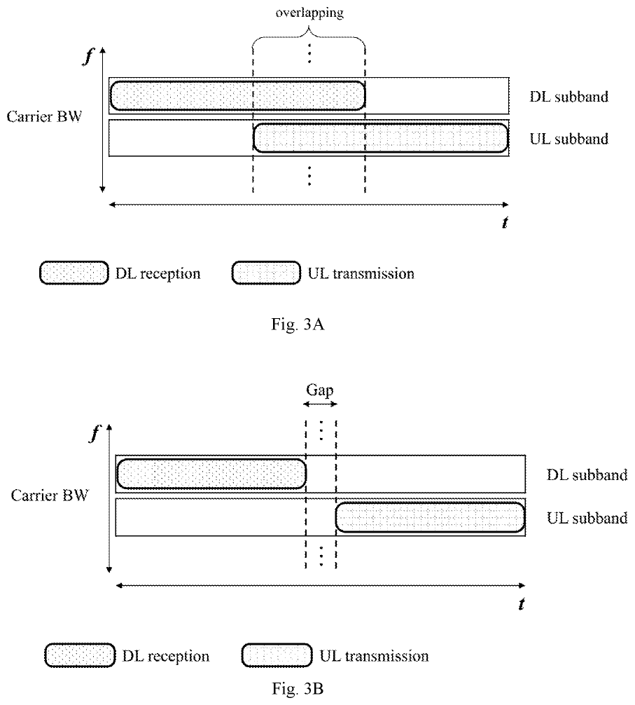

In the wireless communications system 100 operating SBFD mode, a UE may still operate in the half duplex mode, that is, the UE doesn't support transmitting and receiving simultaneously, so in some cases, there may be a conflict between the DL reception and the UL transmission in time domain for the UE. FIGS. 3A and 3B illustrate some scenarios where a conflict occurs between a DL reception and an UL transmission in accordance with some embodiments of the present disclosure.

In FIG. 3A and 3B, there may be at least one DL subband and at least one UL subband within one carrier. From a UE's perspective, the UE is provided with a first set of REs corresponding to an UL transmission within the UL subband and a first set of REs corresponding to a DL reception within the DL subband. Hereinafter in the present disclosure, the DL reception at the UE side signifies a DL transmission at a BS side, and the UL transmission at the UE side signifies an UL reception at the BS side.

In the frequency domain, the first set of REs and the second set of REs do not overlap. However in the time domain, the two sets of REs may overlap. Since the UE may operate in the half duplex mode, there would be a conflict between the DL reception and the UL transmission in the scenario as shown in FIG. 3A.

In FIG. 3B, the two sets of REs corresponding to the UL transmission and DL reception respectively may not overlap in the time domain, furthermore, there is a time gap (marked as “Gap” in FIG. 3B) between the two sets of REs in the time domain. The UE may perform uplink/downlink switching (U/D switching) between the DL reception and UL transmission. The UE may report a capability of U/D switching time “t” to the BS, in other words, the UE may need a time duration with the length “t” to switch from UL transmission to DL reception, or switch from DL reception to UL transmission. When the time gap between the two sets of REs in the time domain is shorter than “t”, the UE may determine that there is a conflict between performing the UL transmission and the DL reception. When the time gap is longer than “t”, the UE may determine that there is no conflict between performing the UL transmission and the DL reception.

The present disclosure proposes some solutions for solving the above conflicts as shown in FIGS. 3A and 3B. Hereinafter the time interval unit “symbol” is used, and persons skilled in the art may know that the solution of the present disclosure also apply to other time domain resource units such as “slot”, “frame”, “subframe”, etc.

A straightforward solution is: each type of UL/DL transmission is assigned a priority level and the transmission(s) associated with a lower priority level is dropped. However, simply dropping the transmission(s) is not effective for some capable devices.

The present disclosure proposes some solutions for handing such conflicts.

In some embodiments, a UE may be provided by a DCI message and/or a higher layer signaling with a set of REs corresponding to an UL transmission, and the set of REs span a set of symbols in time domain, that is, the UE may receive the DCI message and/or the higher layer signaling (hereinafter referred to as a first indication) associated with the UL transmission (hereinafter referred to as a first UL transmission) in the set of symbols (hereinafter referred to as a first set of symbols). Similarly, the UE may also receive a second indication associated with a DL reception (hereinafter referred to as the first DL reception) in another set of symbols (hereinafter referred to as a second set of symbols). The first UL transmission may be associated with a priority level (hereinafter referred to as a first priority level), and the first DL reception may be associated with another priority level (hereinafter referred to as a second priority level).

Correspondingly, at the BS side, the BS may transmit the first indication associated with the first UL transmission in the first set of symbols, and may also transmit the second indication associated with the first DL reception in the second set of symbols. Regarding the first priority level or the second priority level, they may be indicated by the BS or preconfigured, etc.

When the UE determines that there may be a conflict between the first UL transmission and the first DL reception, the UE may compare the first priority level associated with the first UL transmission and the second priority level associated with the first DL reception.

There comparison results may include the following three cases:
Case 1: the first priority level associated with the first UL transmission is lower than the second priority level associated with the first DL reception;
Case 2: the first priority level associated with the first UL transmission is higher than the second priority level associated with the first DL reception; and
Case 3: the first priority level associated with the first UL transmission is the same as the second priority level associated with the first DL reception.

The BS may also perform the above comparison, thus the BS is aware of the results, and may perform similar actions as the following UE actions.

### Case 1

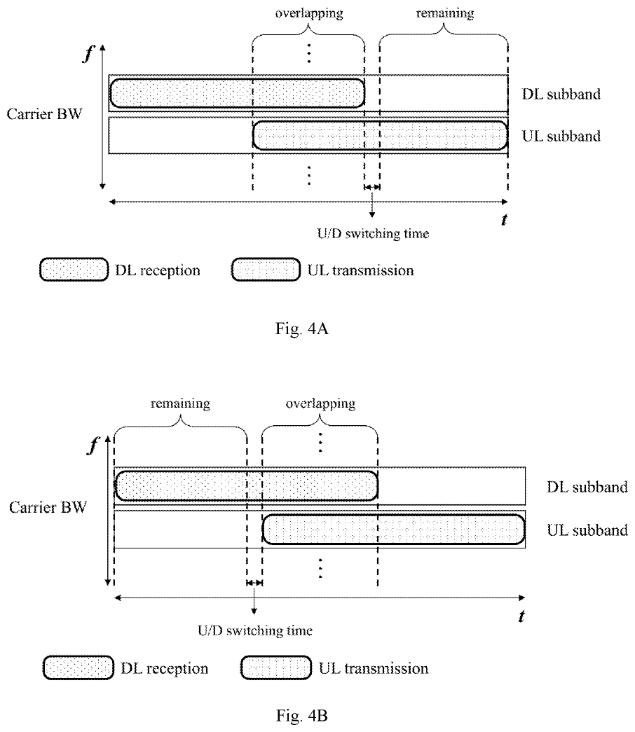

FIG. 4A illustrates a method for handling conflicts in accordance with some embodiments of the present disclosure. More specifically, the method relates to Case 1.

In FIG. 4A, there is a conflict between the first DL reception and the first UL transmission, and the first priority level associated with the first UL transmission is lower than the second priority level associated with the first DL reception. Therefore, the first DL reception may be prioritized, and may be performed by the UE completely. Within the second set of symbols (including the overlapping symbols), the UE performs the first DL reception as indicated by the BS. The UE may also perform the first UL transmission, thus a U/D switching time is required. Accordingly, the first set of symbols for the first UL transmission may be divided into three sets: a set of overlapping symbols, a set of symbols for U/D switching, and a set of remaining symbols. Since the set of overlapping symbols is occupied by the first DL reception, and the set of symbols for U/D switching is for U/D switching, there is only the set of remaining symbols that may be used for the first UL transmission.

Regarding how to perform the first UL transmission in the set of remaining symbols, several solutions are proposed:

### Solution 1-1

In the case that the first UL transmission is a CBG-based transmission, the UE may puncture the first UL transmission, and perform the punctured UL transmission in the set of remaining symbols.

In some embodiments, the punctured UL transmission may include at least one DMRS transmission, and at least one CBG transmission, or both, that is, the set of remaining symbols may include a symbol(s) for at least one DMRS transmission, a symbol(s) for at least one CBG transmission, or both. In some other embodiments, the punctured UL transmission may further include a CG-UCI transmission, that is, the set of remaining symbols may further include a symbol(s) for the CG-UCI transmission.

In conclusion, the UE may perform the first DL reception in the second set of symbols, and perform the punctured UL transmission in the set of remaining symbols. Correspondingly, at the BS side, the BS may perform the first DL transmission in the second set of symbols, and perform the punctured UL reception in the set of remaining symbols.

In the case that the first UL transmission is a not a CBG-based transmission, the UE may drop the whole first UL transmission. In other words, the UE may only perform the first DL reception in the second set of symbols and not perform the first UL transmission. Correspondingly, at the BS side, the BS may perform the first DL transmission (corresponding to the first UL reception from the UE's perspective) in the second set of symbols, and may not perform the first UL reception (corresponding to the first UL transmission from the UE's perspective).

### Solution 1-2

The UE may determine the total number of symbols of the set of remaining symbols for the first UL transmission, and the total number may be denoted as M1 for simplicity. A preconfigured number of symbols, denoted as X1 for simplicity, may be configured, for example, by the BS, by the specification, etc. In the case that the total number of symbols of the set of remaining symbols is larger than or equal to the preconfigured number, i.e., M1≥X1, the UE may determine a new TB with a new TB size based on the total number of remaining symbols, i.e., based on M1. The UE may generate a new UL transmission carrying the new TB, and then perform the new UL transmission carrying the new TB in the set of remaining symbols.

In some embodiments, the new UL transmission may include a CG-UCI transmission, that is, the set of remaining symbols may include a symbol(s) for the CG-UCI transmission.

In conclusion, the UE may perform the first DL reception in the second set of symbols, and perform the new UL transmission in the set of remaining symbols. Correspondingly, the BS may also perform the similar operations as the UE (such as compare the priority levels, and determine whether M1≥X1 or not), and at the BS side, the BS may perform the first DL transmission (corresponding to the first UL reception from the UE's perspective) in the second set of symbols, and perform the new UL reception (corresponding to the new UL transmission from the UE's perspective) in the set of remaining symbols.

In the case that the total number of symbols of the set of remaining symbols is smaller than the preconfigured number, i.e., M1<X1, the UE may drop the whole first UL transmission. In other words, the UE may only perform the first DL reception in the second set of symbols and not perform the first UL transmission. Correspondingly, at the BS side, the BS may perform the first DL transmission (corresponding to the first UL reception from the UE's perspective) in the second set of symbols, and may not perform the first UL reception (corresponding to the first UL transmission from the UE's perspective)

### Solution 1-3

A preconfigured number of symbols, denoted as X1′ for simplicity, and a preconfigured value of a code rate, denoted as Y1 for simplicity, may be configured, for example, by the BS, by the specification, etc.

The UE may determine the total number of symbols of the set of remaining symbols for the first UL transmission, denoted as M1′ for simplicity, and a new code rate corresponding to a new UL transmission, denoted as N1 for simplicity, wherein the new UL transmission is performed in the set of remaining symbols and carries the same TB corresponding to the first UL transmission.

In the case that the total number of symbols of the set of remaining symbols is larger than the preconfigured number, i.e., M1′>X1′, and the new code rate is smaller than Y1, i.e., N1<Y1, the UE may reuse the TB corresponding to the first UL transmission and generate a new UL transmission carrying the same TB. The new UL transmission may be transmitted in the set of remaining symbols.

In some other embodiments, the new UL transmission may include a CG-UCI transmission, that is, the set of remaining symbols may include a symbol(s) for the CG-UCI transmission.

In conclusion, the UE may perform the first DL reception in the second set of symbols, and perform the new UL transmission in the set of remaining symbols. Correspondingly, the BS may also perform the similar operations as the UE (such as compare the priority levels, and determine whether M1′>X1′ or not, whether N1<Y1 or not), and at the BS side, the BS may perform the first DL transmission (corresponding to the first UL reception from the UE's perspective) in the second set of symbols, and may perform the new UL reception (corresponding to the new UL transmission from the UE's perspective) in the set of remaining symbols.

In the case that the total number of symbols of the set of remaining symbols is not larger than the preconfigured number, i.e., M1′≤X1′, or the new code rate is not smaller than Y1, i.e., N1≥Y1, (that is, M1′≤X1′ and N1<Y1; M1′>X1′ and N1≥Y1; or M1′≤X1′ and N1≥Y1), the UE may drop the whole first UL transmission. In other words, the UE may only perform the first DL reception in the second set of symbols and not perform the first UL transmission. Correspondingly, at the BS side, the BS may perform the first DL transmission (corresponding to the first UL reception from the UE's perspective) in the second set of symbols, and may not perform the first UL reception (corresponding to the first UL transmission from the UE's perspective)

In some embodiments, the UE and the BS may determine which solution to use based on the UE capability, pre-configuration, indication of the UE, indication of the BS, a latency requirement, etc. In some other embodiments, which solution (i.e. the above solutions 1-1, 1-2, or 1-3) to use may be preconfigured.

### Case 2

FIG. 4B illustrates another method for handling conflicts in accordance with some embodiments of the present disclosure. More specifically, the method relates to Case 2.

In FIG. 4B, the second priority level associated with the first DL reception is lower than the first priority level associated with the first UL transmission, and the first UL transmission in the first set of symbols is performed by the UE completely. That is, within the first set of symbols (including the overlapping symbols), the UE may perform the first UL transmission as indicated by the BS. The UE may perform the first DL reception, thus a U/D switching time is required. Accordingly, the second set of symbols for the first DL reception may be divided into three sets, a set of overlapping symbols, a set of symbols for U/D switching, and a set of remaining symbols. Since the set of overlapping symbols is occupied by the first UL transmission, the set of symbols for U/D switching is for U/D switching, there is only the set of remaining symbols that may be used for the first DL reception.

Regarding how to perform the first DL reception in the set of remaining symbols, several solutions are proposed:

### Solution 2-1

In the case that the first DL transmission is a CBG-based transmission (corresponding to the first DL reception is a CBG-based transmission from the UE's perspective), the BS may puncture the first DL transmission, and perform the punctured DL transmission in the set of remaining symbols.

In some embodiments, the punctured DL transmission may include at least one DMRS transmission, and at least one CBG transmission, or both, that is, the set of remaining symbols may include a symbol(s) for at least one DMRS transmission, a symbol(s) for at least one CBG transmission, or both.

In conclusion, the BS may perform the first UL reception in the first set of symbols, and perform the punctured DL transmission in the set of remaining symbols. Correspondingly, the UE may perform similar operations as the BS (such as determining comparing the priority levels, and determining whether first DL transmission is a CBG-based transmission), and may perform the first UL transmission in the first set of symbols, and perform the punctured DL reception in the set of remaining symbols.

In the case that the first DL transmission is a not a CBG-based transmission, the BS may drop the whole first DL transmission. In other words, the BS may only perform the first UL reception (corresponding to the first UL transmission from the UE's perspective) in the first set of symbols, and not perform the first DL transmission (corresponding to the first DL reception from the UE's perspective). Correspondingly, at the UE side, the UE may only perform the first UL transmission in the first set of symbols, and not perform the first DL reception.

### Solution 2-2

The BS may determine the total number of symbols of the set of remaining symbols for the first DL reception, and the total number may be denoted as M2 for simplicity. A preconfigured number of symbols, denoted as X2 for simplicity, may be configured, for example, by the BS, by the specification, etc. In the case that the total number of symbols of the set of remaining symbols is larger than or equal to the preconfigured number, i.e., M2≥X2, the BS may determine a new TB with a new TB size based on the total number of remaining symbols, i.e., based on M2. The BS may generate a new DL transmission carrying the new TB, and then transmit the new DL transmission carrying the new TB in the set of remaining symbols. Correspondingly, at the UE side, the UE also perform similar operations as the BS (such as compare the priority levels, determining whether M2≥X2 or not and determining the new TB with the new TB size based on the total number of remaining symbols, i.e., based on M2), the UE is aware that the BS may perform the new DL transmission (corresponding to the new DL transmission from the UE's perspective), and may perform the new DL reception carrying the new TB in the set of remaining symbols.

In conclusion, the BS may perform the first UL reception in the first set of symbols, and perform the new DL transmission in the set of remaining symbols. Correspondingly, the UE may perform similar operations as the BS (such as determining comparing the priority levels, and determining whether M2≥X2 or not), and may perform the first UL transmission in the first set of symbols, and perform the new DL reception in the set of remaining symbols.

In the case that the total number of symbols of the set of remaining symbols is smaller than the preconfigured number, i.e., M2<X2, the BS may drop the whole first DL transmission. In other words, the BS may only perform the first UL reception (corresponding to the first UL transmission from the UE's perspective) in the first set of symbols, and not perform the first DL transmission (corresponding to the first DL reception from the UE's perspective). Correspondingly, at the UE side, the UE may only perform the first UL transmission in the first set of symbols, and not perform the first DL reception.

### Solution 2-3

A preconfigured number of symbols, denoted as X2′ for simplicity, and a preconfigured value of the code rate, denoted as Y2 for simplicity, may be configured, for example, by the BS, by the specification, etc.

The BS may determine the total number of symbols of the set of remaining symbols for the first DL transmission, denoted as M2′ for simplicity, and a new code rate corresponding to a new DL transmission, denoted as N2 for simplicity, wherein the new DL transmission is performed in the set of remaining symbols and carries the same TB corresponding to the first DL transmission.

In the case that the total number of symbols of the set of remaining symbols is larger than the preconfigured number, i.e., M2′>X2′, and the new code rate is smaller than Y2, i.e., N2<Y2, the BS may reuse the TB corresponding to the first DL transmission and generate a new DL transmission carrying the same TB. The new DL transmission may be transmitted in the set of remaining symbols.

In conclusion, the BS may perform the first UL reception in the first set of symbols, and perform the new DL transmission in the set of remaining symbols. Correspondingly, the UE may perform similar operations as the BS (such as determining comparing the priority levels, and determining whether M2′>X2′ or not and whether N2<Y2 or not), and may perform the first UL transmission in the first set of symbols, and perform the new DL reception in the set of remaining symbols.

In the case that the total number of symbols of the set of remaining symbols is not larger than the preconfigured number, i.e., M2′≤X2′, or the new code rate is not smaller than Y2, i.e., N2≥Y2, (that is, M2′≤X2′ and N2<Y2, M2′>X2′ and N2≥Y2; or M2′≤X2′ and N2>Y2), the BS may drop the whole first DL transmission. In other words, the BS may only perform the first UL reception (corresponding to the first UL transmission from the UE's perspective) in the first set of symbols, and not perform the first DL transmission (corresponding to the first DL reception from the UE's perspective). Correspondingly, at the UE side, the UE may only perform the first UL transmission in the first set of symbols, and not perform the first DL reception.

In some embodiments, the UE and the BS may determine which solution to use based on the UE capability, pre-configuration, indication of the UE, indication of the BS, a latency requirement, etc. In some other embodiments, which solution (i.e. the above solutions 2-1. 2-2, or 2-3) to use may be preconfigured.

### Case 3

In this case, the first priority level and the second priority level are identical. In this case, the BS may transmit an indication to the UE, to indicate whether an UL reception or a DL transmission is prioritized in the case that the first priority level and the second priority level are identical. The indication may be carried by a physical downlink control channel (PDCCH) transmission, a higher layer signaling, or the like. Alternatively, the UE may transmit an indication to the BS, to indicate whether an UL transmission or a DL reception is prioritized in the case that the first priority level and the second priority level are identical. The indication may be carried by a PUCCH transmission, or the like. For example, if the DL transmission at the BS side or the DL reception at the UE side is prioritized, the UE and the BS may operate according to any one of the above solutions 1-1, 1-2, or 1-3. For another example, if the UL reception at the BS side or the UL transmission at the UE side is prioritized, the UE and the BS may operate according to any one of the above solutions 2-1, 2-2, or 2-3. When the first priority level and the second priority level are identical, and the BS is not aware whether the UL transmission or the DL reception is prioritized at the UE side, the BS may perform both the indicated UL reception and the indicated DL transmission regardless whether they overlap in the time domain or not since the BS is capable of performing in the full duplex mode. At the UE side, the UE may decide whether to prioritize the UL transmission or the DL reception based on the UE implementation. In the case that an UL transmission is not performed, the UE may resend the UL transmission. In the case that a DL reception is missed, the UE may send a request for the DL reception.

In some embodiments, when the UE determines that there is a conflict between the UL transmission and the DL reception, the UE may apply a new mapping rule for at least one of DMRS or CG-UCI. The mapping rule aims to avoid from dropping the UL transmission or the DL reception, and is known by both the UE and the BS.

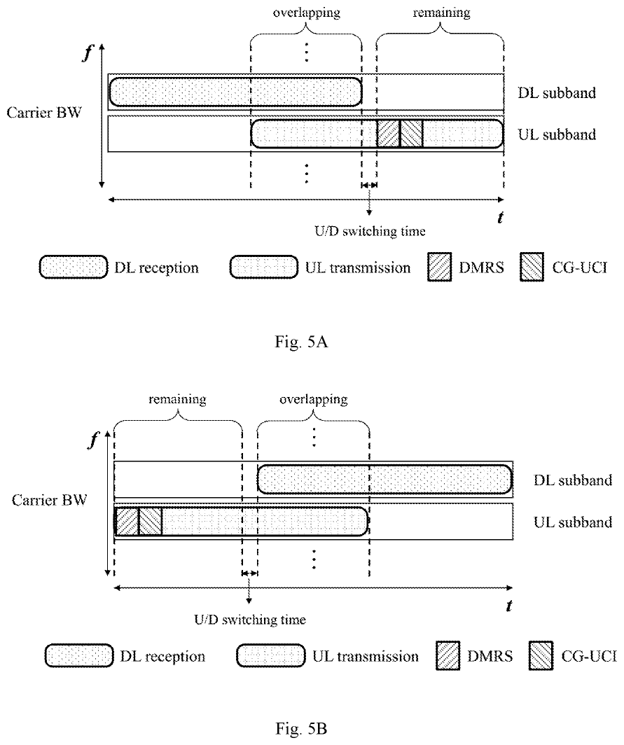

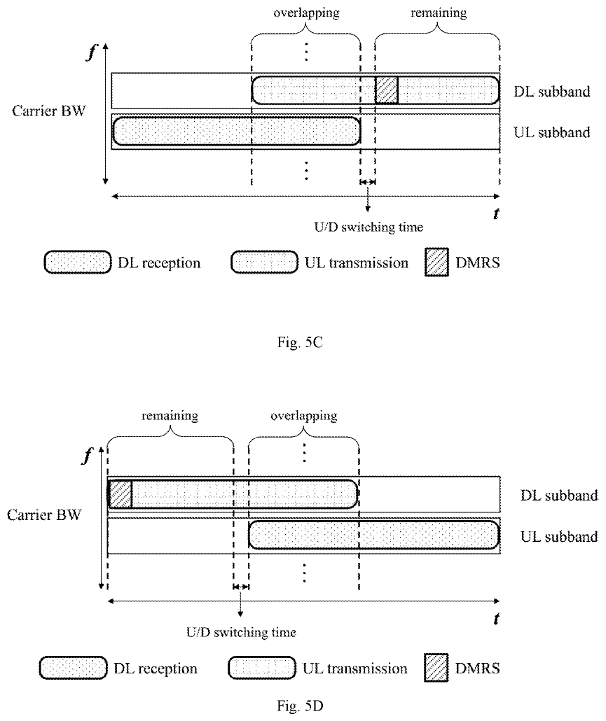

FIGS. 5A-5D illustrate some mapping methods in accordance with some embodiments of the present disclosure

In FIGS. 5A-5D, there is a conflict between the DL reception and the UL transmission (from a UE's perspective). The priority level associated with the DL reception is higher than the priority level associated with the UL transmission in FIGS. 5A and 5B. Therefore, the DL reception may be prioritized, and may be performed by the UE completely. The symbols for performing the UL transmission may be divided into three sets, and a set of remaining symbols may be included in the three sets. In FIG. 5A, the DL reception is performed earlier than the UL transmission in the time domain, and in FIG. 5B, the DL reception is performed later than the UL transmission in the time domain.

The priority level associated with the DL reception is lower than the priority level associated with the UL transmission in FIGS. 5C and 5D. The UL transmission may be prioritized, and may be performed by the UE completely. The symbols for performing the DL reception may be divided into three sets, and a set of remaining symbols may be included in the three sets. In FIG. 5C, the DL reception is performed earlier than the UL transmission in the time domain; in FIG. 5D, the DL reception is performed later than the UL transmission in the time domain.

The present disclosure proposes to map the symbol(s) for the DMRS transmission starting from the first symbol in the set of remaining symbols. The symbol(s) for the CG-UCI transmission may be mapped following the symbol(s) for the DMRS transmission in the set of remaining symbols.

For example, in FIGS. 5A and 5B, the block marked by left dashed lines may represent the symbol(s) for the DMRS transmission. The block marked by right dashed lines may represent the symbol(s) for the CG-UCI transmission.

For example, in FIGS. 5C and 5D, the block marked by left dashed lines may represent the symbol(s) for the DMRS transmission, which is mapped from the first symbol in the set of remaining symbols.

In some other embodiments, the DMRS transmission may be mapped to other symbols in the set of remaining symbols, for instance, mapping from the middle symbol, from the last symbol, etc. The CG-UCI transmission may also be mapped to other symbols in the set of remaining symbols, for instance, mapping from the middle symbol, from the last symbol, etc.

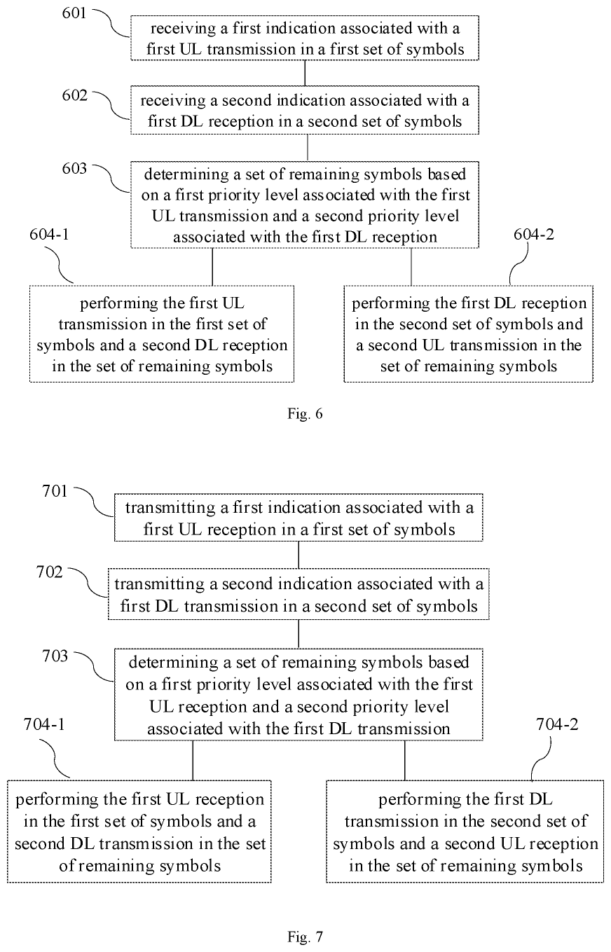

FIG. 6 illustrates a method performed by a UE for wireless communication in accordance with some embodiments of the present disclosure.

In operation 601, the UE may receive a first indication associated with a first UL transmission in a first set of symbols; in operation 602, the UE may receive a second indication associated with a first DL reception in a second set of symbols. In operation 603, the UE may determine a set of remaining symbols based on a first priority level associated with the first UL transmission and a second priority level associated with the first DL reception. In operation 604-1, the UE may perform the first UL transmission in the first set of symbols and a second DL reception in the set of remaining symbols in the case that the set of remaining symbols is included in the second set of symbols. In operation 604-2, the UE may perform the first DL reception in the second set of symbols and a second UL transmission in the set of remaining symbols in the case that the set of remaining symbols is included in the first set of symbols. That is, the operation 604-1 and operation 604-2 are performed under different conditions.

In some embodiments, in the case that the first priority level is lower than the second priority level, or in the case that the first priority level is equal to the second priority level and the first DL reception is prioritized, the set of remaining symbols is included in the first set of symbols, and is neither overlapped with the second set of symbols nor used as a gap for UL/DL switching. For example, in FIG. 4A, the first priority level associated with the first UL transmission is lower than the second priority level associated with the first DL reception, the set of remaining symbols is represented with the block with cross lines, it is included in the first set of symbols for the first UL transmission, and is neither overlapped with the second set of symbols nor used as a gap for UL/DL switching.

In some embodiments, in the case that the first priority level is higher than the second priority level, or in the case that the first priority level is equal to the second priority level and the first UL transmission is prioritized, the set of remaining symbols is included in the second set of symbols, and is neither overlapped with the first set of symbols nor used as a gap for UL/DL switching. For example, in FIG. 4B, the first priority level associated with the first UL transmission is higher than the second priority level associated with the first DL reception, the set of remaining symbols is represented with the block with vertical dotted lines, it is included in the second set of symbols for the first DL reception, and is neither overlapped with the first set of symbols nor used as a gap for UL/DL switching.

In some embodiments, the set of remaining symbols includes one or more symbols for at least one of: a DMRS transmission or at least one CBG transmission.

In some embodiments, the DMRS transmission is mapped from a first symbol in the set of remaining symbols. In some embodiments, a CG-UCI transmission is mapped from a symbol following symbol(s) for the DRMS transmission in the set of remaining symbols. For example, in FIG. 5A, the DMRS transmission is mapped from the first symbol in the set of remaining symbols, and the CG-UCI transmission is mapped from a symbol following symbol(s) for the DRMS transmission in the set of remaining symbols.

In some embodiments, the second UL transmission in the set of remaining symbols may be a punctured first UL transmission (for example, the second UL transmission in solution 1-1); an UL transmission carrying a TB different from a TB carried in the first UL transmission in the case that a total number of symbols of the set of remaining symbols (e.g., M1) is larger than or equal to a first number (e.g., X1) (for example, the second UL transmission in solution 1-2); or an UL transmission carrying the TB carried in the first UL transmission in the case that a total number of symbols of the set of remaining symbols (e.g., M1) is larger than a second number (e.g., X1′) and a code rate (e.g., N1) corresponding to the second UL transmission is smaller than a third number (e.g., Y1) (for example, the second UL transmission in solution 1-3).

In some embodiments, the second DL reception in the set of remaining symbols includes one of the following: a punctured first DL reception (for example, the second DL reception in solution 2-1); a DL reception carrying a TB different from a TB carried in the first DL reception in the case that a total number of symbols of the set of remaining symbols (e.g., M2) is larger than or equal to a fourth number (e.g., X2) (for example, the second DL reception in solution 2-2); a DL reception carrying the TB carried in the first DL reception in the case that a total number of symbols of the set of remaining symbols (e.g., M2) is larger than a fifth number (e.g., X2′) and a code rate (e.g., N2) corresponding to the second UL reception is smaller than a sixth number (e.g., Y2) (for example, the second DL reception in solution 2-3).In some embodiments, the UE may transmit a third indication indicating an UL transmission or a DL reception is prioritized in the case that a priority level associated with the UL transmission is equal to a priority level associated with the DL reception. The third indication may include a PUCCH transmission, RRC signaling, or the like.

In some embodiments, the UE may receive a fourth indication indicating an UL transmission or a DL reception is prioritized in the case that a priority level associated with the UL transmission is equal to a priority level associated with the DL reception. The fourth indication may include a PDCCH transmission, RRC signaling, or the like.

In some embodiments, the UE may drop the first UL transmission in the case that the first priority level is lower than the second priority level, or in the case that the first priority level is equal to the second priority level and the first DL reception is prioritized, and wherein one of the following condition is fulfilled: the first UL transmission is not a CBG-based transmission, a total number of symbols of the set of remaining symbols is smaller than a first number; a total number of symbols of the set of remaining symbols is smaller than or equal to a second number, or a code rate corresponding to the second UL transmission is larger than or equal to a third number.

In some embodiments, the UE may drop the first DL reception in the case that the first priority level is higher than the second priority level, or in the case that the first priority level is equal to the second priority level and the first UL transmission is prioritized, and wherein one of the following condition is fulfilled: the first DL reception is not a CBG-based reception; a total number of symbols of the set of remaining symbols is smaller than a fourth number; or a total number of symbols of the set of remaining symbols is smaller than or equal to a fifth number, or a code rate corresponding to the second UL reception is larger than or equal to than a sixth number.

FIG. 7 illustrates a method performed by a BS for wireless communication in accordance with some embodiments of the present disclosure.

In operation 701, the BS may transmit a first indication associated with a first UL reception in a first set of symbols. In operation 702, the BS may transmit a second indication associated with a first DL transmission in a second set of symbols. In operation 703, the BS may determine a set of remaining symbols based on a first priority level associated with the first UL reception and a second priority level associated with the first DL transmission. In operation 704-1, the BS may perform the first UL reception in the first set of symbols and a second DL transmission in the set of remaining symbols in the case that the set of remaining symbols is included in the second set of symbols. In operation 704-2, the BS may perform the first DL transmission in the second set of symbols and a second UL reception in the set of remaining symbols in the case that the set of remaining symbols is included in the first set of symbols. That is, the operation 704-1 and operation 704-2 are performed under different conditions.

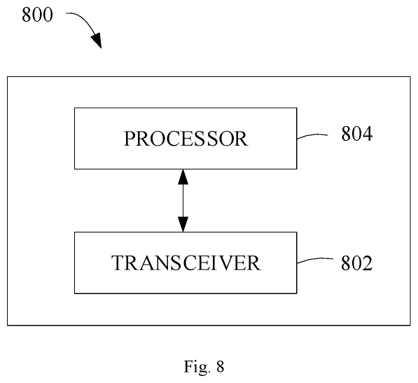

FIG. 8 illustrates a simplified block diagram of an apparatus for handling conflicts in accordance with some embodiments of the present disclosure.

As shown in FIG. 8, an example of the apparatus 800 may include at least one processor 804 and at least one transceiver 802 coupled to the processor 804. The apparatus 800 may be a UE, a BS, a RAN node, a source node, a target node, a third node, or any other device with similar functions.

Although in this figure, elements such as the at least one transceiver 802 and processor 804 are described in the singular, the plural is contemplated unless a limitation to the singular is explicitly stated. In some embodiments of the present disclosure, the transceiver 802 may be divided into two devices, such as a receiving circuitry and a transmitting circuitry. In some embodiments of the present disclosure, the apparatus 800 may further include an input device, a memory, and/or other components.

In some embodiments of the present disclosure, the apparatus 800 may be a UE. The transceiver 802 and the processor 804 may interact with each other so as to perform the operations of the UE described in any of FIGS. 1-7. In some embodiments of the present disclosure, the apparatus 800 may be a node. The transceiver 802 and the processor 804 may interact with each other so as to perform the operations of the node described in any of FIGS. 1-7.

In some embodiments of the present disclosure, the apparatus 800 may further include at least one non-transitory computer-readable medium.

For example, in some embodiments of the present disclosure, the non-transitory computer-readable medium have stored thereon computer-executable instructions to cause the processor 804 to implement the method with respect to the UE as described above. For example, the computer-executable instructions, when executed, cause the processor 804 interacting with transceiver 802 to perform the operations of the UE described in any of FIGS. 1-7.

In some embodiments of the present disclosure, the non-transitory computer-readable medium may have stored thereon computer-executable instructions to cause the processor 804 to implement the method with respect to the node as described above. For example, the computer-executable instructions, when executed, cause the processor 804 interacting with transceiver 802 to perform the operations of the node described in any of FIGS. 1-7.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first.” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including.” “having.” and the like, as used herein, are defined as “comprising.”

1. A user equipment (UE), comprising:
at least one memory; and
at least one processor coupled with the at least one memory and configured to cause the UE to:
receive a first indication associated with a first uplink (UL) transmission in a first set of symbols;
receive a second indication associated with a first downlink (DL) reception in a second set of symbols;
determine a set of remaining symbols based on a first priority level associated with the first UL transmission and a second priority level associated with the first DL reception; and
perform one of the following:
perform the first UL transmission in the first set of symbols and a second DL reception in the set of remaining symbols in response to the set of remaining symbols being included in the second set of symbols; or
perform the first DL reception in the second set of symbols and a second UL transmission in the set of remaining symbols response to the set of remaining symbols being included in the first set of symbols.

2. The UE of claim 1, wherein, if the first priority level is lower than the second priority level, or if the first priority level is equal to the second priority level and the first DL reception is prioritized, the set of remaining symbols is included in the first set of symbols, and is neither overlapped with the second set of symbols nor used as a gap for UL/DL switching.

3. The UE of claim 1, wherein, if the first priority level is higher than the second priority level, or if the first priority level is equal to the second priority level and the first UL transmission is prioritized, the set of remaining symbols is included in the second set of symbols, and is neither overlapped with the first set of symbols nor used as a gap for UL/DL switching.

4. The UE of claim 1, wherein the set of remaining symbols includes one or more symbols for at least one of: a demodulation reference signal (DMRS) transmission or at least one code block group (CBG) transmission.

5. The UE of claim 4, wherein the DMRS transmission is mapped from a first symbol in the set of remaining symbols.

6. The UE of claim 5, wherein a configured grant uplink control information (CG-UCI) transmission is mapped from a symbol following symbol(s) for the DRMS transmission in the set of remaining symbols.

7. The UE of claim 1, wherein the second UL transmission in the set of remaining symbols is one of the following:
a punctured first UL transmission;
an UL transmission carrying a transport block (TB) different from a TB carried in the first UL transmission if a total number of symbols of the set of remaining symbols is larger than or equal to a first number; or
an UL transmission carrying the TB carried in the first UL transmission if a total number of symbols of the set of remaining symbols is larger than a second number and a code rate corresponding to the second UL transmission is smaller than a third number.

8. The UE of claim 1, wherein the second DL reception in the set of remaining symbols includes one of the following:
a punctured first DL reception;
a DL reception carrying a transport block (TB) different from a TB carried in the first DL reception if a total number of symbols of the set of remaining symbols is larger than or equal to a fourth number; or
a DL reception carrying the TB carried in the first DL reception if a total number of symbols of the set of remaining symbols is larger than a fifth number and a code rate corresponding to a second UL reception is smaller than a sixth number.

9. The UE of claim 1, wherein the at least one processor is configured to cause the UE to:
transmit a third indication indicating an UL transmission or a DL reception is prioritized if a priority level associated with the UL transmission is equal to a priority level associated with the DL reception; or
receive a fourth indication indicating an UL transmission or a DL reception is prioritized if a priority level associated with the UL transmission is equal to a priority level associated with the DL reception.

10. The UE of claim 1, wherein the at least one processor is configured to cause the UE to:
drop the first UL transmission if the first priority level is lower than the second priority level, or if the first priority level is equal to the second priority level and the first DL reception is prioritized, wherein one of the following condition is fulfilled:
the first UL transmission is not a CBG-based transmission,
a total number of symbols of the set of remaining symbols is smaller than a first number;
a total number of symbols of the set of remaining symbols is smaller than or equal to a second number, or a code rate corresponding to the second UL transmission is larger than or equal to a third number; or
drop the first DL reception if the first priority level is higher than the second priority level, or if the first priority level is equal to the second priority level and the first UL transmission is prioritized, wherein one of the following condition is fulfilled:
the first DL reception is not a CBG-based reception;
a total number of symbols of the set of remaining symbols is smaller than a fourth number; or
a total number of symbols of the set of remaining symbols is smaller than or equal to a fifth number, or a code rate corresponding to a second UL reception is larger than or equal to than a sixth number.

11. A base station, comprising:
at least one memory; and
at least one processor coupled with the at least one memory and configured to cause the base station to:
transmit a first indication associated with a first uplink (UL) reception in a first set of symbols;
transmit a second indication associated with a first downlink (DL) transmission in a second set of symbols;
determine a set of remaining symbols based on a first priority level associated with the first UL reception and a second priority level associated with the first DL transmission; and
perform one of the following:
perform the first UL reception in the first set of symbols and a second DL transmission in the set of remaining symbols in response to the set of remaining symbols being included in the second set of symbols; or
perform the first DL transmission in the second set of symbols and a second UL reception in the set of remaining symbols in response to the set of remaining symbols being included in the first set of symbols.

12. The base station of claim 11, wherein, if the first priority level is lower than the second priority level, or if the first priority level is equal to the second priority level and the first DL transmission is prioritized, the set of remaining symbols is included in the first set of symbols, and is neither overlapped with the second set of symbols nor used as a gap for UL/DL switching.

13. The base station of claim 11, wherein, if the first priority level is higher than the second priority level, or if the first priority level is equal to the second priority level and the first UL reception is prioritized, the set of remaining symbols is included in the second set of symbols, and is neither overlapped with the first set of symbols nor used as a gap for UL/DL switching.

14. The base station of claim 11, wherein the set of remaining symbols includes one or more symbols for at least one of: a demodulation reference signal (DMRS) transmission or at least one code block group (CBG) transmission.

15. A method performed by a user equipment (UE), the method comprising:
receiving a first indication associated with a first uplink (UL) transmission in a first set of symbols;
receiving a second indication associated with a first downlink (DL) reception in a second set of symbols;
determining a set of remaining symbols based on a first priority level associated with the first UL transmission and a second priority level associated with the first DL reception; and
performing one of the following:
performing the first UL transmission in the first set of symbols and a second DL reception in the set of remaining symbols in response to the set of remaining symbols being included in the second set of symbols; or
performing the first DL reception in the second set of symbols and a second UL transmission in the set of remaining symbols in response to the set of remaining symbols being included in the first set of symbols.

16. A processor for wireless communication, comprising:
at least one controller coupled with at least one memory and configured to cause the processor to:
receive a first indication associated with a first uplink (UL) transmission in a first set of symbols;
receive a second indication associated with a first downlink (DL) reception in a second set of symbols;
determine a set of remaining symbols based on a first priority level associated with the first UL transmission and a second priority level associated with the first DL reception; and
perform one of the following:
perform the first UL transmission in the first set of symbols and a second DL reception in the set of remaining symbols in response to the set of remaining symbols being included in the second set of symbols; or
perform the first DL reception in the second set of symbols and a second UL transmission in the set of remaining symbols in response to the set of remaining symbols being included in the first set of symbols.

17. The processor of claim 16, wherein, if the first priority level is lower than the second priority level, or if the first priority level is equal to the second priority level and the first DL reception is prioritized, the set of remaining symbols is included in the first set of symbols, and is neither overlapped with the second set of symbols nor used as a gap for UL/DL switching.

18. The processor of claim 16, wherein, if the first priority level is higher than the second priority level, or if the first priority level is equal to the second priority level and the first UL transmission is prioritized, the set of remaining symbols is included in the second set of symbols, and is neither overlapped with the first set of symbols nor used as a gap for UL/DL switching.

19. The processor of claim 16, wherein the set of remaining symbols includes one or more symbols for at least one of: a demodulation reference signal (DMRS) transmission or at least one code block group (CBG) transmission.

20. The processor of claim 19, wherein the DMRS transmission is mapped from a first symbol in the set of remaining symbols.
